(19) United States
(12) Patent Application Publication
(10) Pub. No.: US 2006/0082131 A1
(43) Pub. Date: Apr. 20, 2006

(54) Rib-it folder

(76) Inventor: Myrol A Sweeney, Renton, WA (US)

Correspondence Address: MYROL A. SWEENEY, 315 So. Third St., Renton, WA, 98055, US

(21) Appl. No.: 10/944,348

(22) Filed: Sep. 20, 2004

(51) Int. Cl. B42D 1/00

(52) U.S. Cl. 281/45; 281/28

(57) ABSTRACT

The Rib-It Folder is a “presentation folder” or “portfolio cover” with two novel features. The “rib” keeps material that is placed in the pocket and tucked under the flap from crossing over the center fold of the folder and getting bent when the folder is folded closed. The “Flop Stopper” flap keeps in place loose sheets or thin bound booklets that are tucked under this flap, preventing them from falling (or flopping) out of the glued pocket below.

I am hereby offering my application for a utility patent concerning two features of my enclosed Rib-it Folder. A generic name for the folder is “presentation folder” or “portfolio cover” that I have found when surfing the internet to determine to the best of my knowledge that there are no products in the marketplace that include these features.

### The Rib-It Dates Conceived and Progression

6-12-03-Idea for the Rib-it presentation folder.

6-14-03-first physical mockup.

7-24-03-Drawing of logo and layout.

12-30-03-First sale of a folder incorporating the “rib” feature. Idea shown to customer with a plain paper mock-up. Customer is microMed, a subsidiary of Oculus, Petaluma, Calif.

4-29-04-copy writing, layout and promotional sample folder design finished incorporating both features.

6-22-04-artwork finished for promotional sample folder sample.

7-08-04-finished folder ready for sample marketing.

7-16-04-presentation of promotional sample folder to a potential customer, Iris Window Coverings, Renton Wash.

What is claimed is:

1. Feature claim #1 for patent is described as the “rib” which keeps material that is placed in the pocket and tucked under the flap from crossing over the center fold of the folder and getting bent when the folder is folded closed.

2. Feature claim #2 for patent is described as the “Flop Stopper” flap. Loose sheets or thin bound booklets can be tucked under this flap which keeps them in place, preventing them from falling (or flopping) out of the glued pocket below.
